(19) United States
(12) Patent Application Publication
(10) Pub. No.: US 2025/0289569 A1
(43) Pub. Date: Sep. 18, 2025

(54) AIR-GROUND TRANSPORTATION SYSTEMS WITH ADVANCED SAFETY

(71) Applicant: Alexander Skalov, New York, NY (US)

(72) Inventor: Alexander Skalov, New York, NY (US)

(21) Appl. No.: 19/224,726

(22) Filed: May 31, 2025

(51) Int. Cl. B64C 39/02; B64D 11/06

(52) U.S. Cl. CPC B64C 39/026; B64D 11/0619; B64D 11/0689; B64D 11/0696; B64D 11/0697; B64D 11/0698

(57) ABSTRACT

A transportation system includes a body, a plurality of propulsion units, and a control unit. The body defines an interior space. The plurality of propulsion units are mounted on the body. Each of the plurality of propulsion units includes a thrust-generating mechanism and a power source. The thrust-generating mechanism is configured to produce a propulsion force. The control unit is operatively coupled to each of the plurality of propulsion units. The transportation system further includes a housing unit or a pilot attachment disposed within the interior space. The housing unit or the pilot attachment is suspended by at least one connecting element or a suspension mechanism which is configured to dampen and/or stabilize and/or actively adjust movement relative to the body.

### FIELD OF DISCLOSURE

The present disclosure relates generally to the field of transportation. More specifically, it relates to air-ground transportation systems, and particularly to systems featuring hybrid aerial and terrestrial movement capabilities and enhanced safety structures.

### BACKGROUND

Unmanned Aerial Vehicles (UAVs) have seen significant advancements in recent years, driven by demand for enhanced operational capabilities in areas such as surveillance, delivery, and disaster response. However, traditional UAV propulsion and control systems face limitations in scalability, modularity, energy efficiency, and maintenance requirements. These challenges hinder the ability to perform extended missions, adapt to varying operational needs, and maintain reliability under demanding conditions.

Furthermore, most existing systems are optimized solely for aerial movement and do not effectively support integrated air-ground mobility or dynamic safety enhancements. Current designs often lack adaptable structures that improve impact resilience, modular propulsion configurations, or autonomous recovery features in the event of failures.

Therefore, there remains a need for advanced transportation systems that combine aerial and terrestrial mobility, offer modular and detachable propulsion solutions, enhance safety through dynamic structural adaptations, and improve operational flexibility and endurance across a range of environments.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a transportation system comprising a body, a plurality of propulsion units, and a control unit. Further, the body defines an interior space. Further, the body may include at least one of a polyhedral, a spherical, or other geometric configuration. Further, the plurality of propulsion units may be mounted to the body. Further, each of the plurality of propulsion units may include a thrust-generating mechanism and a power source. Further, the thrust-generating mechanism may be disposed within the interior space of the body, on the body, or external to the body. Further, the thrust-generating mechanism may be operatively coupled to the power source. Further, the power source may be configured to drive the thrust-generating mechanism. Further, the power source may be one of: a dedicated source associated with each of the plurality of propulsion units, or a shared source supplying the plurality of propulsion units. Further, the thrust-generating mechanism may be configured to produce a propulsion force characterized by at least one of direction and magnitude. Further, the control unit may be operatively coupled to each of the plurality of propulsion units. Further, the control unit may be disposed within, disposed on, integrated into, or remote from the body.

In some embodiments, the transportation system further includes one or more housing units and/or one or more pilot attachments disposed within the interior space of the body. Further, the one or more pilot attachments may be configured to be attached to one or more pilots. Further, each housing unit or each pilot attachment may be suspended within the body by at least one connecting element or a suspension mechanism. Further, the at least one connecting element or the suspension may be configured to secure at least one of the one or more housing units or at least one of the one or more pilots attachments to the body, and further configured to dampen and/or stabilize and/or actively adjust movement of at least one of the one or more housing units or at least one of the one or more pilot attachments during operation of the transportation system. Further, each housing unit may include at least one of a seat or a compartment.

In some embodiments, one or more of the plurality of propulsion units may be configured to be detachably attached to the body. Further, in an embodiment, at least one of the plurality of propulsion units may be configured to autonomously operate with functionality analogous to that of an unmanned aerial vehicle.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure and, together with the description, serve to explain aspects of the invention.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a front view of a transportation system 300, in accordance with some embodiments.

FIG. 4 is a front view of the transportation system 300, in accordance with some embodiments.

FIG. 5 is a front view of the transportation system 300, in accordance with some embodiments.

FIG. 6 is a front view of the housing unit 402, in accordance with some embodiments.

FIG. 7 is a front view of the housing unit 402, in accordance with some embodiments.

FIG. 8 is a front view of the housing unit 402, in accordance with some embodiments.

FIG. 9 is a front view of the housing unit 402, in accordance with some embodiments.

FIG. 10 is a front view of the transportation system 300, in accordance with some embodiments.

FIG. 11 is a front view of the housing unit 402, in accordance with some embodiments.

FIG. 12 is a cross sectional view of the transportation system 300, in accordance with some embodiments.

FIG. 13 is a front view of a dual-operator housing unit 1302, in accordance with some embodiments.

FIG. 14 is a front view of a configuration of circular two-axis gimbal-mounted propulsion units in the transportation system, in accordance with some embodiments.

FIG. 15 is an illustration of an aerodynamic profile associated with a frame of the transportation system, in accordance with some embodiments.

FIG. 16 is an illustration of a propulsion unit of the transportation system, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

### Computing and Sensor Integration

In some embodiments, the transportation system may further comprise one or more computing devices configured for data processing, storage, communication, and control tasks related to system operation. The computing devices may interact with various onboard and external sensors, including but not limited to, location sensors (e.g., GPS), environmental sensors (e.g., temperature, pressure, humidity), biometric sensors, and other contextual variable sensors. Further, the one or more computing devices may include a quantum computer. Further, the quantum computer includes one or more quantum processors. Further, the quantum computer uses quantum technologies for performing logical operations. Further, the one or more computing devices are Artificial Intelligence (AI)/Machine learning (ML) enabled. Further, the one or more computing devices use one or more of Artificial Intelligence (AI) models/algorithms, and Machine learning (ML) models/algorithms for performing one or more data processing tasks, one or more operations, etc. Authentication mechanisms may be optionally included, such as password-based, device-based, or biometric authentication systems, to authorize user commands or control handoff operations. System behavior, including control input responses and autonomous functions, may optionally be adapted based on real-time or historical contextual data. Communications between system elements may occur over wired and/or wireless channels and may include local, remote, or distributed architectures.

### Overview of Flight Control Architecture at Signal Level

In some embodiments, the transportation system may include a central flight computer configured to receive user commands, sensor inputs, and external data, and to generate corresponding control signals for the propulsion modules.

### External Airspace Data Integration

In some embodiments, the central flight computer may be configured to receive real-time airspace data from external sources, such as a control tower associated with a nearby airport. This data may include the positions, trajectories, and flight paths of other aerial vehicles operating in the vicinity. The system may predict potential trajectory conflicts and adjust movement plans accordingly. Although the vehicle's structure reduces collision risks, avoidance remains preferred.

### Pilot-Controlled Flight Mode

In piloted versions, a user (pilot) may transmit directional commands via a remote control device, either from within the cabin or externally. The central flight computer interprets these high-level directional inputs, applies stabilization algorithms (similar to those used in multirotor UAVs), and generates low-level control signals for each propulsion module based on sensor inputs including, but not limited to, gyroscopes, altimeters, accelerometers, GPS modules, cameras, LIDAR, and radar.

If no obstacles are detected via computer vision and no conflict warnings are received from external airspace data, the system converts directional commands into individual control signals for each propulsion module. Each module may be uniquely identified to avoid signal interference. Commands are transmitted wirelessly from the central flight computer to the receivers associated with each propulsion module.

### Signal Path to Propulsion Modules

In an example signal path, a control signal from the central flight computer is wirelessly received by a propulsion module, processed by a microcontroller, and routed to an electronic speed controller (ESC) associated with one or more electric motors, thereby adjusting the propeller thrust according to the desired thrust value.

### Autonomous Propulsion Modules

In embodiments featuring detachable autonomous propulsion modules, each module may include an onboard flight controller and a suite of sensors for independent stabilization and operation. These modules may be capable of adjusting thrust vectors when suspended in a gimbal mount, enabling more precise attitude control and dynamic response during flight. The central flight computer may also monitor the operational status, charge level, and temperature of autonomous modules via wireless telemetry.

### Mid-Flight Module Replacement

The central flight computer may be configured to detect fully charged spare propulsion modules positioned at ground locations. If the flight time exceeds available battery capacity, the system may autonomously initiate a mid-air module replacement. A fully charged module may launch from the ground and autonomously dock with the vehicle, while the depleted module detaches, switches to autonomous flight mode, and navigates to a base for recharging.

### Autonomous Flight Mode

In autonomous flight configurations, a user may select a destination point via a user interface device (e.g., tablet or control panel). The central flight computer automatically calculates the required flight commands based on destination coordinates, environmental conditions, obstacle mapping, airspace data, and available propulsion modules.

### Flight Control System Redundancy

In some embodiments, the transportation system may include multiple redundant flight computers. For example, three flight computers may continuously process incoming sensor and command data, while a fourth computer verifies outgoing commands. If discrepancies are detected among the primary computers, outlier data may be excluded prior to transmitting final control commands to the propulsion modules. Collectively, these units are referred to as the Central Flight Computer System.

### Emergency Control Handoff

In the event of a critical situation, external control towers may be configured to securely assume remote control of the vehicle by transmitting secure override commands to the central flight computer.

### Gimbal Suspension Control

In embodiments featuring gimbal-suspended propulsion modules, the central flight computer may additionally determine optimal thrust angles (pitch and roll) for each module. The control signals may include both thrust magnitude and gimbal positioning commands. In the case of autonomous modules, local onboard flight controllers may independently manage thrust vectoring based on received target parameters and local sensor feedback, while passive gimbal suspension allows those adjustments to occur without active control.

### Unified Control Philosophy

In all configurations, whether piloted or autonomous, the central flight computer system processes high-level directional commands, environmental data, and airspace information to dynamically generate propulsion commands for the vehicle. Human pilots provide high-level navigation inputs; the system autonomously handles stabilization, thrust distribution, and gimbal adjustments as necessary for flight stability and operational safety.

Turning now to the detailed description, various embodiments of the present disclosure are described below with reference to the accompanying drawings and examples. These embodiments are provided for purposes of illustration and explanation and are not intended to limit the scope of the disclosure. Features from different embodiments may be combined without departing from the scope of the invention.

### Overview:

The present disclosure describes an advanced transportation system incorporating innovative features aimed at improving safety, minimizing noise, and enhancing efficiency and user experience. The transportation system includes a body comprising an interior space and a housing unit and/or one or more pilot attachments disposed within the interior space. The housing unit and/or one or more pilot attachments is designed for one or more pilots or occupants operating or traveling within the transportation system. The housing unit is connected to the body via one or more connecting (damping) elements or a suspension mechanism configured to provide both structural rigidity and flexibility. These connecting (damping) elements or the suspension mechanism are strategically placed to absorb vibrations, mitigate the effects of collisions or falls, and/or maintain stability, and/or actively adjust the relative movement of the housing unit with respect to the body during flight and ground operations, thereby safeguarding pilots.

In some embodiments, compliance with relevant regulatory guidelines, such as those prescribed by the Federal Aviation Administration (FAA) or local municipal authorities, can be incorporated into the construction and operational processes.

### Structural Design and Housing Unit Configuration

In some embodiments, the body assumes a polygonal shape, formed from interconnected polygonal segments. The structure may alternate pentagonal and hexagonal segments, forming a tessellated frame that enhances structural rigidity and aerodynamic transparency. A preferred embodiment features a truncated icosahedron configuration, resembling a soccer ball, optimizing the balance between aerodynamic transparency and structural rigidity.

Further, the body may be constructed using lightweight materials such as carbon fiber tubes and modular connectors, allowing for ease of maintenance and scalable assembly. The housing unit may include an external housing structure and an internal housing structure interconnected via a gyro-stabilizing device, further improving in-flight stability and pilot comfort. The external housing structure may correspond to the overall shape of the body, without necessarily conforming to an aerodynamic design.

In some embodiments, the connecting elements or the suspension mechanism are configured to provide controlled flexibility in absorbing movements and/or stabilization, offering improved shock absorption compared to traditional rigid structures.

In some embodiments, the connecting elements or the suspension mechanism are configured to actively adjust the relative movement of the housing unit with respect to the body, wherein the suspension mechanism may comprise one or more components of the type used in gyroscopically stabilized mechanisms, and may include servos to adjust the position and/or orientation.

In some embodiments, propulsion units and associated power sources are distributed throughout the body to enhance thermal management and system resilience. Further, in the event that any individual propulsion unit or power source incurs damage or thermal failure, the resulting fire is inherently contained within the affected unit due to its physical separation from other components, preventing escalation and maintaining the overall flight integrity of the transportation system, even during active operations.

### Flight Propulsion and Control Systems

In some embodiments, propulsion units are mounted at various locations of the body. Each propulsion unit includes a thrust-generating mechanism, such as a screw device, a ducted fan assembly, a cyclocopter mechanism, or any other aerodynamic thrust-generating device, and an individual or shared power source to ensure independent operation and improved thermal management.

In some embodiments, the thrust-generating mechanisms are disposed entirely within the internal cavity of the body. This configuration protects the propulsion units from external impacts and allows the transportation system to roll across surfaces without damaging the thrust modules.

Further, the transportation system includes a control unit operatively coupled with the propulsion units. Each propulsion unit may have a unique identifier to prevent interference, and control signals are transmitted wirelessly. Signals are processed locally at each propulsion unit and routed to electronic speed controllers to regulate motor output.

Further, in addition to wireless communication between the control unit and individual propulsion units, in some embodiments, the transportation system may facilitate direct wireless communication between component modules themselves, improving flexibility in command handling without requiring physical interconnections.

In embodiments featuring gimbal-mounted propulsion units, the control unit may calculate and command both thrust magnitude and optimal thrust angles (pitch and roll) for each unit to enhance maneuverability and energy efficiency.

Further, the system may operate in multiple control modes, including manual operation from inside the housing unit, remote wireless operation, and fully autonomous control.

### Safety Features and Redundancy

In some embodiments, the transportation system includes multiple flight controller modules that provide redundant verification. For example, three flight controller modules may process incoming sensor and control data, and a central flight controller module may validate outgoing commands by cross-checking the outputs. In case of discrepancies, the system can isolate faulty signals and maintain safe operation.

Further, the transportation system may include provisions for secure takeover by external control towers in emergency situations.

The connecting elements or the suspension mechanism and structural design absorb shocks and impacts and/or stabilize, protecting pilots and internal systems during collisions, loss of control, or emergency landings.

In some embodiments, by reducing transmitted vibrations and providing a stable environment within the housing unit, the transportation system may also indirectly contribute to reducing pilot fatigue during extended missions, thereby enhancing operational safety and endurance.

### Ground Mobility and Energy Efficiency

In addition to flight, the transportation system may be configured to roll across surfaces under its own power. The rolling functionality enables precision maneuvers such as garage parking and facilitates energy-efficient travel when flight is unnecessary.

Further, aerodynamic efficiency is enhanced through the use of optimized aerodynamic profiles integrated into the body. Electromechanical actuators such as servos may adjust the angles of attack of the aerodynamic profiles, modify their shapes, or perform both adjustments simultaneously based on the flight phase and direction.

In some embodiments, the body may rotate during flight, and the control unit may adjust aerodynamic surfaces accordingly. This coordinated adjustment facilitates a flight behavior similar to cyclocopter-style operations, improving thrust efficiency, lift control, and overall flight dynamics.

### Vertical Takeoff and Landing (VTOL)

The present disclosure also supports vertical takeoff and landing capabilities. The propulsion units are designed and positioned to enable the transportation system to ascend or descend vertically, enhancing operational flexibility in confined or urban environments. This capability solves limitations associated with traditional fixed-wing aircraft designs.

### Modularization and Maintenance

In some embodiments, each propulsion unit is independently powered and configured to detach from and reattach to the body. In case of battery depletion or mechanical failure, the system may autonomously swap modules mid-flight.

In some embodiments, each propulsion unit may also be built as an independent unmanned aerial vehicle (UAV) capable of autonomous operation and automatic docking with the main body of the transportation system, enabling a flexible, scalable modular aerial transportation architecture.

In some embodiments, spare fully charged modules can be launched from pre-positioned ground stations along the transportation system's route and automatically connect to designated locations on the body. Upon the approach of a replacement module, the corresponding depleted module detaches and navigates to a safe landing zone for recharging. This system maintains continuous transportation system operation without requiring a full system shutdown or manual intervention.

### Sensor Integration, Computing Systems, and Autonomous Operation

In some embodiments, the transportation system integrates a wide range of sensors including GPS receivers, environmental sensors (such as temperature, pressure, and humidity sensors), biometric sensors, and obstacle detection systems such as LIDAR and radar.

Further, the transportation system may include one or more cameras configured to capture visual data. The visual data may be processed by one or more onboard systems to assist in navigation, obstacle detection, environmental awareness, flight stability, turbulence recognition, weather condition monitoring, and other operational tasks. The use of cameras is not limited to obstacle detection but may support a wide range of functionalities based on the real-time or predictive analysis of the surrounding environment.

Furthermore, any combination of processed data from any sensors may be referred to as computer vision.

Further, computing devices may be configured to manage data processing, storage, communication, and operational control. Authentication mechanisms such as password-based, biometric-based, or device-based security methods may be employed to authorize control commands and emergency interventions.

Further, the control systems can operate adaptively based on real-time contextual data and/or historical information, enabling dynamic route optimization and enhanced safety.

Further, interfaces are designed to simplify control of the transportation system by enabling pilots to issue high-level directional commands, reducing training requirements and improving operational safety.

In some embodiments, the transportation system may include functionality to improve maneuverability by dynamically controlling directionality in flight paths. This allows the transportation system to respond more effectively to changing environments and complex operational requirements, enhancing precision in contexts such as search and rescue missions or precision delivery operations. Directionality control optimizes the trajectory of flight paths, minimizing risks associated with dynamic operations and increasing the overall adaptability and responsiveness of the transportation system.

### Advanced Features and Future Enhancements

In some embodiments, artificial intelligence modules may be incorporated to optimize flight efficiency, propulsion unit operations, improve computer vision processing and system maintenance in real-time based on environmental and operational conditions.

Further, propulsion units may dynamically adjust their thrust outputs to balance loads and maximize resource efficiency. Some designs may include self-healing materials capable of autonomously repairing minor damages to reduce maintenance requirements.

Further, energy harvesting technologies may be included to collect power from solar energy, wind energy, or atmospheric electricity, as well as from evolving wireless power infrastructure, thereby supplementing onboard batteries and extending operational duration.

In some embodiments, the connecting elements or suspension mechanism may be further configured for active control by the control unit or directly by the pilot's command. The system may adjust the position and/or stability of the housing unit relative to the body dynamically, and/or by using pilot's command and/or predictive algorithms and real-time data analysis, thereby optimizing the maneuverability by enabling adjustment of the vehicle's center of mass, and improving pilot experience by reducing the transmission of vibrations during rolling by surface or turbulence encountered during flight operations.

Further, interfaces are designed to simplify control of modular propulsion units, reducing pilot training requirements and improving operational safety.

Further, in consideration of emergency scenarios, connecting elements or suspension mechanism may incorporate foldable features to absorb energy effectively and further protect pilots.

In some embodiments, present disclosure provides an advanced transportation system featuring modular propulsion, aerodynamic optimization, integrated safety structures, vertical takeoff and landing capabilities, wireless coordination between propulsion units, controlled flexibility for shock absorption and/or stabilization, enhanced maneuverability for dynamic operations, fire containment strategies for enhanced operational safety, scalable maintenance solutions, energy harvesting innovations, and dynamic housing unit stabilization and/or position adjustment for optimal pilot experience. These features collectively solve critical limitations found in existing aerial vehicle designs, while establishing a scalable foundation for future mobility solutions.

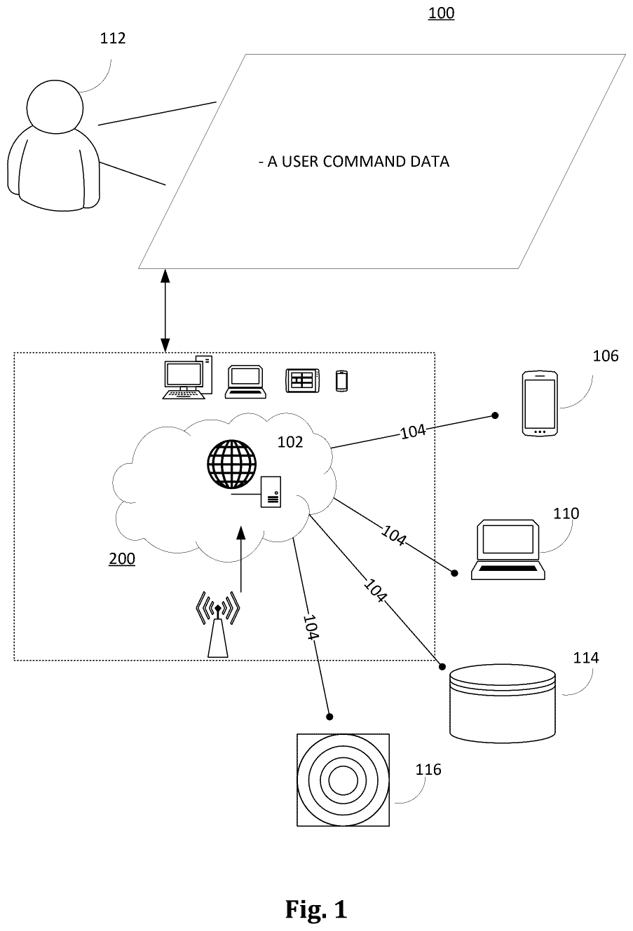

FIG. 1 illustrates an example of an online platform 100 consistent with some embodiments of the present disclosure. The online platform 100 may be hosted on a centralized server 102 and may communicate over a communication network 104 (such as the Internet) with one or more client devices, including mobile devices 106, electronic devices 110 (such as desktop computers or laptops), databases 114, and sensors 116. A user 112 may interact with the platform through a web-based application accessible on a computing device.

The online platform 100 may be configured to facilitate communication, control, monitoring, or management of transportation systems as described herein. In some embodiments, the platform may collect data from vehicles, issue control commands, assist with fleet coordination, or provide information services to users or administrators.

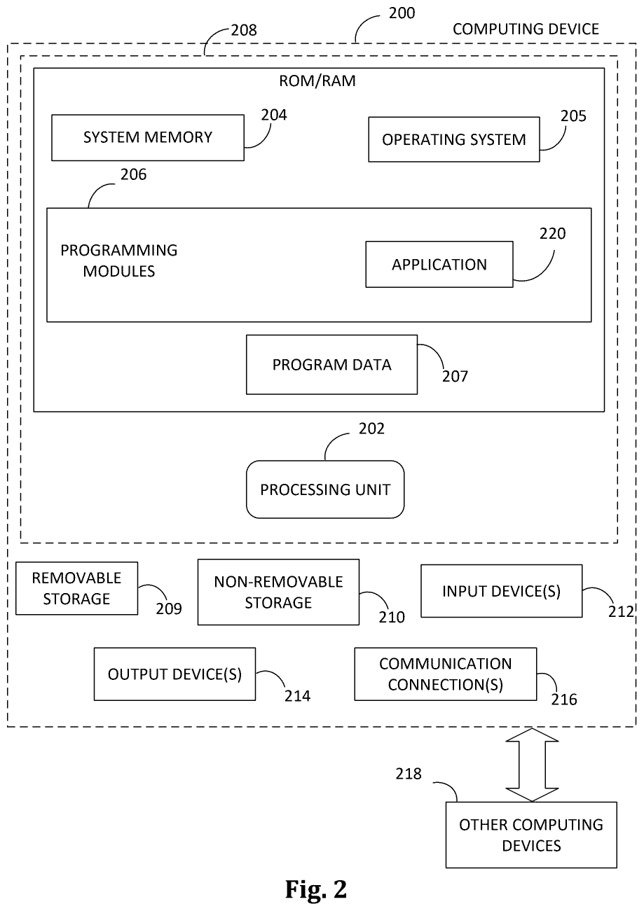

With reference to FIG. 2, a system consistent with an embodiment may include a computing device 200 configured for executing software applications supporting platform operations. Computing device 200 may include at least one processing unit 202, system memory 204, and additional storage options such as removable storage 209 and non-removable storage 210. It may further include input devices 212, output devices 214, and communication interfaces 216 for interacting with other devices 218 across the network.

In some embodiments, the computing device 200 may implement modules such as image processing modules, machine learning modules, and real-time control algorithms associated with transportation system management. Storage media and communication systems used by computing device 200 may comprise any appropriate technology suitable for performing the functions described.

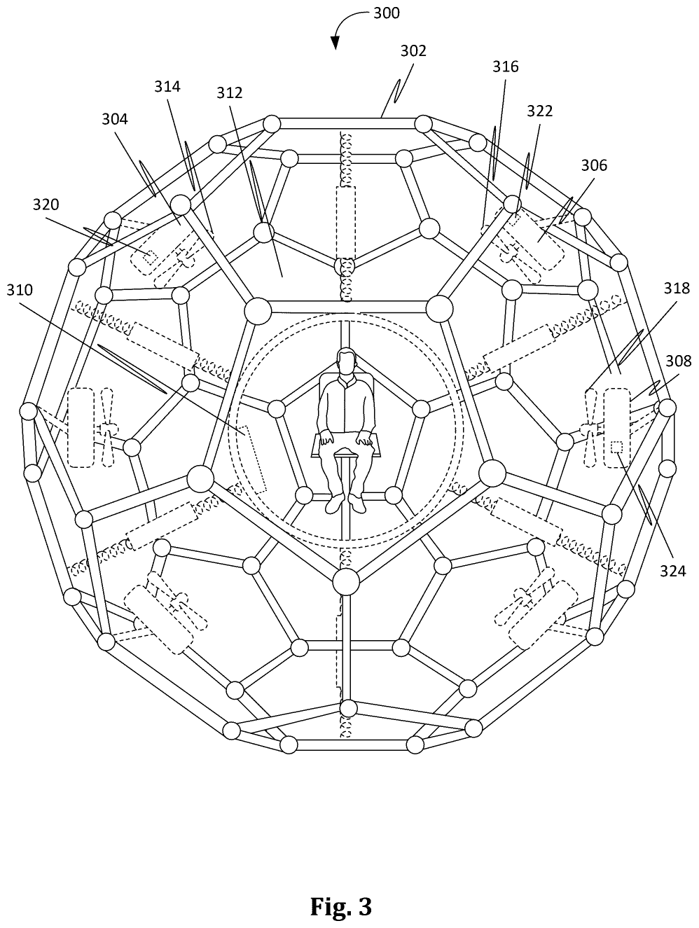

FIG. 3 is a front view of a transportation system 300, in accordance with some embodiments.

Further, the transportation system 300 may include a body 302, a plurality of propulsion units 304-308, and a control unit 310.

Further, the body 302 defines an interior space 312. Further, the body 302 may include at least one of a polyhedral, a spherical, or other geometric configuration. Further, at least one of the polyhedral, the spherical, or the other geometric configuration may correspond to a shape of the body 302. Further, the body 302 may be an external body of the transportation system 300. Further, the transportation system 300 may be an aircraft.

Further, the plurality of propulsion units 304-308 may be mounted on the body 302. Further, the plurality of propulsion units 304-308 may be mounted in one or more locations of the body 302. Further, the plurality of propulsion units 304-308 may be configured for propelling the transportation system 300 for producing one or more movements for the transportation system 300. Further, each of the plurality of propulsion units 304-308 may include a thrust-generating mechanism (314, 316, and 318) and a power source (320, 322, and 324). Further, the thrust-generating mechanism (314, 316, and 318) may be disposed within the interior space 312 of the body 302, on the body 302, or external to the body 302. Further, the thrust-generating mechanism (314, 316, and 318) may include, for example, propellers, ducted-fan assemblies, or other aerodynamic propulsion devices. Further, in an embodiment, the thrust-generating mechanism (314, 316, and 318) may be disposed entirely within the interior space 312. Further, the thrust-generating mechanism (314, 316, and 318) may be operatively coupled to the power source (320, 322, and 324). Further, the power source (320, 322, and 324), which may include batteries, may be configured to power the thrust-generating mechanism (314, 316, and 318). Further, the power source (320, 322, and 324) may be one of: a dedicated source associated with each of the plurality of propulsion units (314, 316, and 318), or a shared source supplying the plurality of propulsion units (314, 316, and 318). Further, the thrust-generating mechanism (314, 316, and 318) may be configured to produce a propulsion force characterized by at least one of direction and magnitude. Further, the propulsion force may include a propulsion thrust. Further, in some embodiments, the plurality of propulsion units 304-308 may be configured to propel the transportation system 300, producing one or more movements including lifting, traversing, landing, rolling, ascending, and descending. Further, the propulsion force may have one or more force characteristics, such as force magnitude and force direction, corresponding to various operational maneuvers or flight operations associated with the transportation system 300. In some embodiments, the thrust-generating mechanism (314, 316, and 318) may be configured to function as a cyclocopter.

Further, the control unit 310 may be operatively coupled with each of the plurality of propulsion units 304-308. Further, the control unit 310 may include a flight computer, a computing device, a quantum computer, a controller, a processor, a processing unit, a microprocessor, a microcontroller, or a control system, and may be configured for controlling one or more operations of the plurality of propulsion units 304-308. Further, the one or more operations may be associated with the producing of the propulsion force with at least one of the direction and the magnitude. Further, the control unit 310 may be disposed within, disposed on, integrated into, or remote from the body 302.

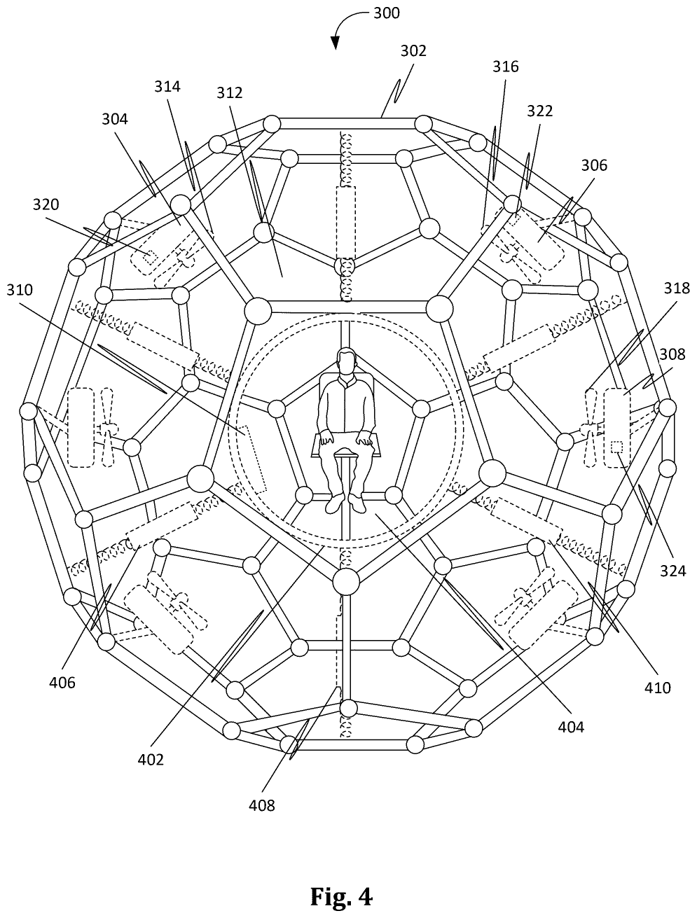

In some embodiments, the transportation system 300 may further include one or more housing units 402 (as shown in FIG. 4) and/or one or more pilot attachments disposed within the interior space 312 of the body 302. Further, the one or more pilot attachments may be configured to be attached to one or more pilots. Further, the one or more pilots may include individuals, etc. Further, the one or more pilot attachments may include a harness, a strap, etc. Further, each housing unit 402 or each pilot attachment may be suspended within the body 302 using one or more connecting elements 406-410 or a suspension mechanism. Further, the one or more connecting elements 406-410 or the suspension mechanism may be configured to secure at least one of the one or more housing units 402 or the one or more pilot attachments to the body 302. Further, the one or more connecting elements 406-410 or the suspension mechanism may be configured to dampen and/or stabilize and/or actively adjust movement of at least one of the one or more housing units 402 or the one or more pilot attachments during operation of the transportation system 300. Further, each housing unit 402 may include at least one of a seat or a compartment. Further, the dampening and/or stabilizing and/or actively adjusting the movement of at least one of the one or more housing units 402 or the one or more pilot attachments enhances stability and comfort for the one or more pilots. Further, in an embodiment, the one or more housing units 402 may include one or more housing interior spaces 404 and may optionally include a cabin. Further, the one or more housing units 402 may be configured to accommodate at least one individual, such as a pilot, an operator, or a passenger, as well as objects or cargo. Further, the one or more connecting elements 406-410 or the suspension mechanism may be used to connect the one or more housing units 402 and/or the one or more pilot attachments to the body 302. Further, the one or more housing units 402 and/or the one or more pilot attachments may be suspended based on a connection between the one or more housing units 402 and/or the one or more pilot attachments and the body 302. In some embodiments, the one or more connecting elements 406-410 or the suspension mechanism may include damping and/or stabilizing and/or actively adjustable elements. In an embodiment, the one or more housing units 402 may be represented by one or more seats, minimal structural components, or even simple connectors (for example, carabiners or similar attachment mechanisms, provided as examples and not intended to be limiting). In such cases, the pilot may be directly coupled to the one or more connecting elements 406-410 or the suspension mechanism via their suit or any other pilot suspension mechanism suitable for attaching the pilot directly to the one or more connecting elements 406-410.

In an embodiment, the one or more housing units 402 and/or the one or more pilot attachments may be suspended relative to the body 302 by the one or more connecting elements 406-410 or the suspension mechanism. Further, the one or more connecting elements 406-410 or the suspension mechanism may be configured to permit and/or actively adjust relative movement and/or dampen and/or stabilize the one or more housing units 402 and/or the one or more pilot attachments relative to the body 302. Further, the one or more connecting elements 406-410 or the suspension mechanism may include one or more of an elastically deformable element, a cable, a flexible plate, a spring, a hydraulic, a pneumatic shock absorber, a gyroscopically stabilized arm(s), a magnetic field suspension, an aerodynamic suspension, and a composite structure allowing relative bending between interconnected elements. Further, the one or more connecting elements 406-410 or the suspension mechanism may be further configured to absorb impact forces resulting from external collisions or operational movements. Further, the one or more connecting elements 406-410 or the suspension mechanism may be implemented using any structure, material, or system capable of allowing relative movement between the one or more housing units 402 and/or the one or more pilots attachments, and the body 302 while dampening and/or stabilizing and/or actively adjusting forces therebetween, including structures and technologies hereafter developed. Further, the one or more connecting elements 406-410 or the suspension mechanism may be further configured to adjust the position and/or orientation of the one or more housing units 402 and/or the one or more pilot attachments within the body 302 in response to a control input from a pilot or an automated system. Further, in an embodiment, an algorithmic control system or a direct user command may adjust the position and/or orientation of the one or more housing units 402 and/or the one or more pilot attachments to shift the vehicle's center of mass in order to improve maneuverability or even enable ground-based jumps or other maneuvers. Further, such adjustment may be dynamically performed to stabilize the position of the one or more housing units 402 and/or the one or more pilot attachments relative to one or more of an external force, a vibration, and a movement associated with the body 302.

In some embodiments, the one or more pilots may be directly suspended within the body 302 of the transportation system 300 via the one or more connecting elements 406-410 or the suspension mechanism, which may be configured to dampen and/or stabilize motion. In other embodiments, the one or more pilots may be seated within the one or more housing units 402, which may be as simple as a seat or include a compartmentalized cockpit. Further, in an embodiment, the transportation system 300 may be configured to accommodate the one or more pilots, either directly suspended or seated within the one or more housing units 402 suspended within the body 302.

In some embodiments, the one or more connecting elements 406-410 or the suspension mechanism includes an elastically deformable element. In some embodiments, the elastically deformable element includes one or more of an elastic band and a cable.

In some embodiments, the one or more housing units 402 include an operator housing unit which may be configured for housing an operator associated with the transportation system 300. Further, the operator is configured to facilitate one or more of a navigation and a management operation associated with the transportation system 300. This incorporation of the operator housing unit is particularly relevant in implementations where its configuration enables the efficient housing of personnel associated with the transportation system 300.

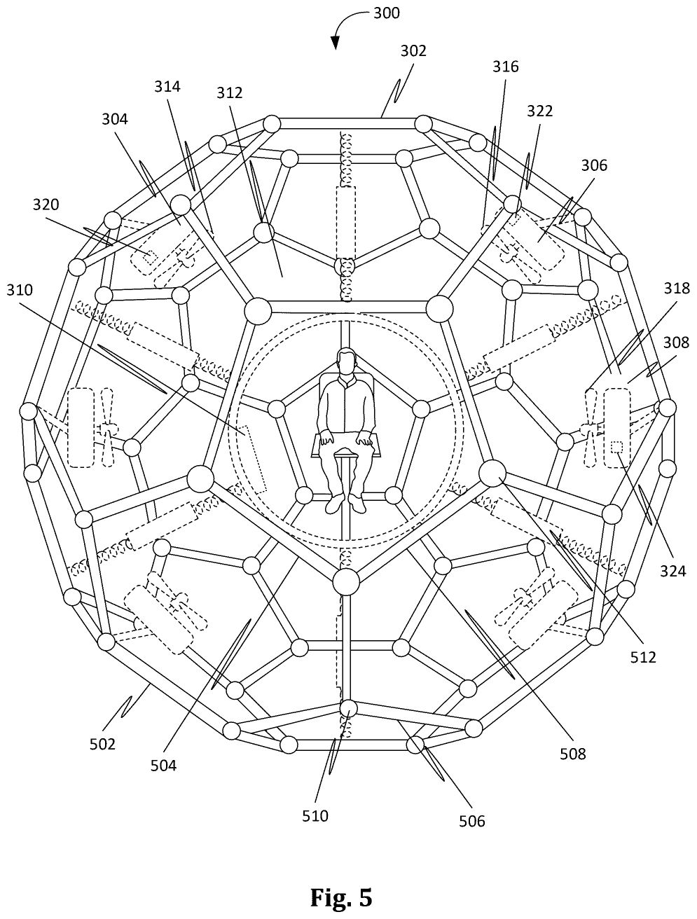

In some embodiments, the body 302 may include a frame 502, as shown in FIG. 5, formed by a plurality of interconnected frame members 504-512. Further, the plurality of interconnected frame members 504-512 may be connected together in an arrangement. Further, the arrangement of the plurality of interconnected frame members 504-512 defines the geometric configuration of the body 302. Further, an overall shape of the body 302 may correspond to the arrangement of the plurality of interconnected frame members 504-512.

In some embodiments, the arrangement includes a spherical arrangement corresponding to the plurality of interconnected frame members 504-512 connected in a spherical configuration. Further, the spherical configuration enables the arrangement of the plurality of interconnected frame members 504-512 in one or more of a cohesive and structurally sound manner. Further, the spherical configuration is configured to facilitate supporting one or more of an overall design and a functionality of the transportation system 300. Further, the spherical configuration facilitates an efficient distribution of one or more of a load and a stress in relation to the plurality of interconnected frame members 504-512, contributing to one or more of an enhanced stability and a durability of the transportation system 300. Further, by leveraging geometric properties associated with a sphere, the spherical configuration promotes optimal structural integrity while minimizing material requirements.

In some embodiments, the plurality of interconnected frame members 504-512 includes a polygonal geometric frame member corresponding to a frame member constituted by two or more polygonal segments. In some embodiments, the two or more polygonal segments include one or more of a pentagonal segment and a hexagonal segment.

In some embodiments, the arrangement includes a truncated icosahedron arrangement.

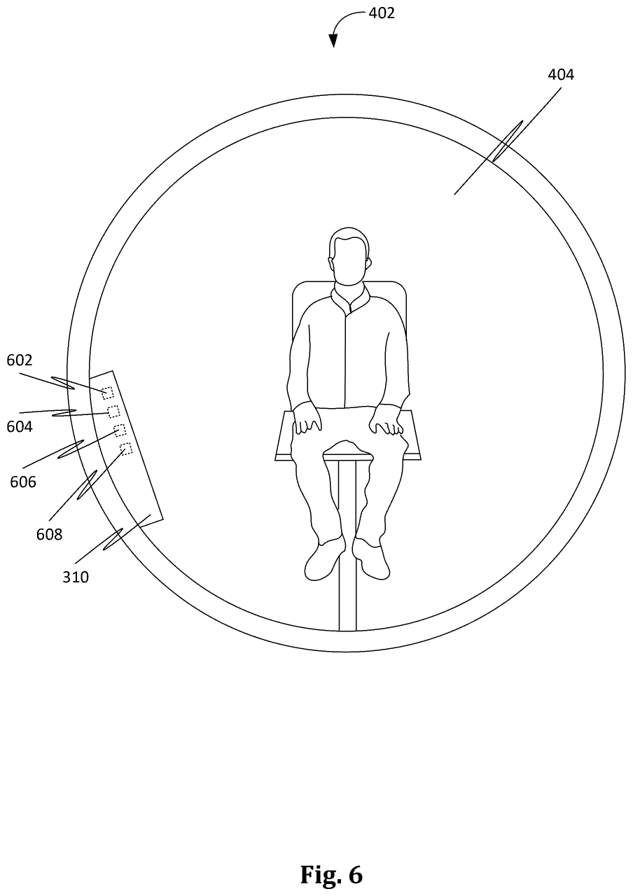

Further, in some embodiments, the plurality of propulsion units 304-308 may be divided into a plurality of propulsion unit groups. Further, the control unit 310 may include a plurality of flight controller modules 602-606, as shown in FIG. 6. Further, each of the plurality of flight controller modules 602-606 may be exclusively assigned to and configured to independently control a corresponding propulsion unit group, such that failure of one of the plurality of flight controller modules 602-606 does not impair operation of the other propulsion unit groups. Further, each flight controller module may be further configured to communicate with its assigned propulsion unit group via a wired or wireless communication link. Further, the plurality of flight controller modules 602-606 may include propulsion modules.

Further, the plurality of flight controller modules 602-606 may be placed on the body 302 and, in some embodiments, may be physically attached to the propulsion modules to allow the propulsion modules to function as independent UAVs.

In some embodiments, the control unit 310 may further include a central flight controller module 608, as shown in FIG. 6, operatively coupled with the plurality of flight controller modules 602-606. Further, the central flight controller module 608 may be configured to monitor the operational status of each flight controller module to assume control of a propulsion unit group upon detection of a failure of its assigned flight controller module. Further, the central flight controller module 608 may be further configured to dynamically redistribute control among multiple propulsion unit groups to maintain stability of the transportation system 300 following the failure. Further, control signals may be distributed from the central flight controller module 608 to the plurality of flight controller modules 602-606 and further to at least one of the plurality of propulsion units 304-308 to perform aerial and/or terrestrial movement of the transportation system 300. Further, in an embodiment, the central flight controller module 608 may control the plurality of flight controller modules 602-606, which in turn control respective groups of the propulsion units 304-308.

In some embodiments, the central flight controller module 608 may be configured to dynamically redistribute control commands among operational propulsion unit groups in response to a detected failure, thereby maintaining stability of the transportation system 300. Redistribution may be performed using predefined control algorithms, real-time feedback from flight sensors, or adaptive learning models.

Further, in an embodiment, the central flight controller module 608 and/or the control unit 310 may be configured for processing one or more data received from at least one of the flight sensors, on-board sensors, ground sensors, data sources, user devices, computing devices, IoT devices, etc., using one or more machine learning models. Further, the one or more data may include airspace data. Further, the central flight controller module 608 and/or the control unit 310 may be configured for generating the control commands based on the processing of the one or more data using the one or more machine learning models. The central flight controller module 608 may include a computing device, processor, microprocessor, microcontroller, quantum computer, or machine learning module. The one or more machine learning models may be adaptive and may take one or more data inputs, perform operations, and produce outputs. These outputs may be used to generate control commands. The one or more machine learning models may include convolutional neural networks, recurrent neural networks, deep neural networks, long short-term memory networks, encoder/decoder architectures (including sequence-to-sequence models), transformers, and attention mechanisms. The one or more machine learning models may be supervised, unsupervised, or semi-supervised. They may be trained, retrained, tuned, optimized, or updated using algorithms such as transfer learning, reinforcement learning, adaptive learning, or deep learning. Real-time feedback loops may be used for training or updating. The attention mechanism may be used in training, optimization, retraining, or tuning of the one or more machine learning models.

In some embodiments, the control unit 310 may further be configured to generate control command data representing a control command associated with the one or more propulsion units 304-308. Further, the transportation system 300 may be propelled based on the control command data.

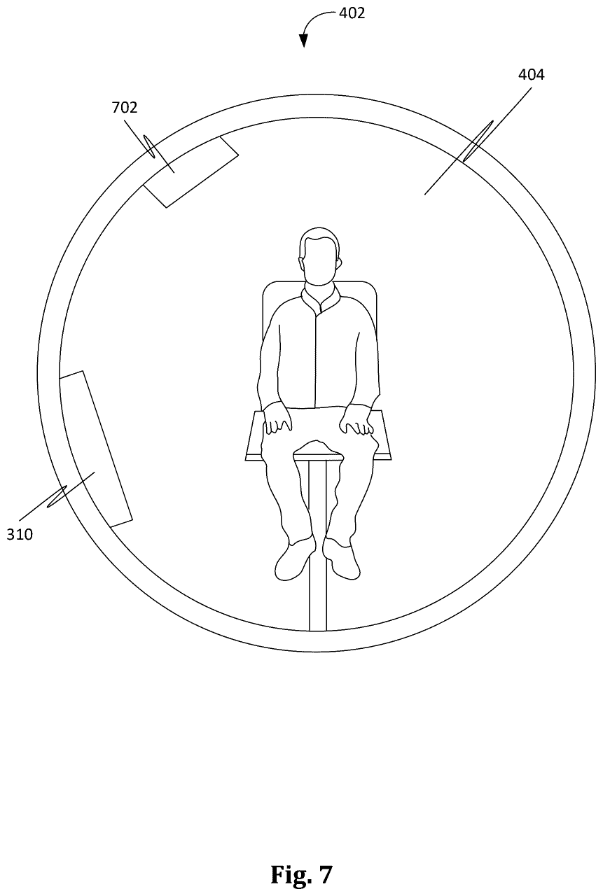

In some embodiments, the transportation system 300 may further include a communication module 702, as shown in FIG. 7. The communication module 702 may include one or more communication devices, communication interfaces, or equivalent components. Further, the communication module 702 may be configured for receiving user command data from a user device associated with a user. Further, the user command data represents a user command in relation to the producing of the propulsion force. Further, the communication module 702 may be communicatively coupled with one or both of at least one of the plurality of propulsion units 304-308 and the central flight controller module 608. Further, the producing of the propulsion force characterized by at least one of the direction and the magnitude may be further based on the user command data. The communication module 702 may be operatively coupled with the control unit 310.

Further, the control unit 310 may be configured to process the received user command data in combination with data from one or more onboard sensors and to generate control command data for the plurality of propulsion units 304-308. The producing of propulsion force may be based, at least in part, on the processed combination of user command data and sensor data.

In some embodiments, the plurality of interconnected frame members 504-512 may include a plurality of tubes 504-508 and a plurality of connectors 510-512. Further, the plurality of tubes 504-508 may be interconnected using the plurality of connectors 510-512. Further, the interconnection of the plurality of tubes 504-508 using the plurality of connectors 510-512 forms the body 302. In some embodiments, each of the plurality of tubes 504-508 may be constituted by a material composition. In some embodiments, the material composition includes one or more of a carbon fiber material composition and a 3D printed material composition.

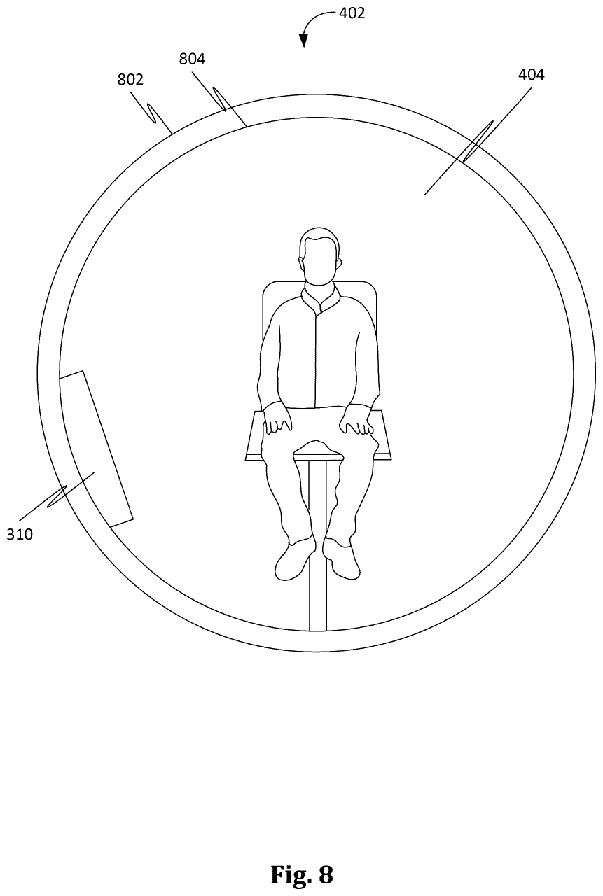

In some embodiments, at least one of the one or more housing units 402, as shown in FIG. 8, may include an exterior housing structure 802 and an interior housing structure 804. The interior housing structure 804 may be operatively coupled to the exterior housing structure 802. Further, the interior housing structure 804 may be disposed at least one part within the exterior housing structure 802.

In some embodiments, at least one of the one or more housing units 402 may be connected to the body 302 based on a connection between the exterior housing structure 802 and the body 302 using the one or more connecting elements 406-410 or the suspension mechanism.

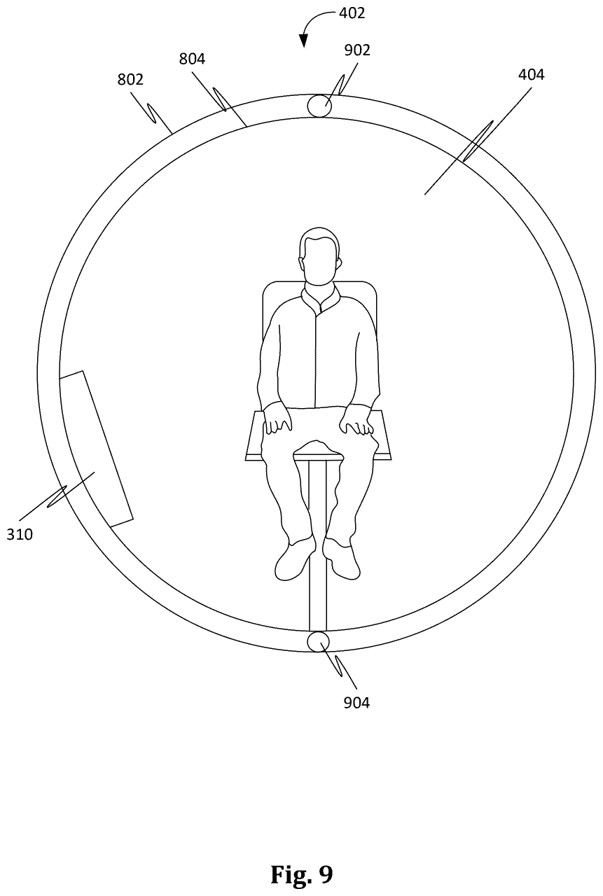

In an embodiment, the transportation system 300 may include a gyro-stabilization unit 902-904, as shown in FIG. 9, operatively coupled to the interior housing structure 804 and the exterior housing structure 802. Further, the gyro-stabilization unit 902-904 may be configured to stabilize an orientation of the interior housing structure 804 relative to rotation and/or movement of the exterior housing structure 802. Further, the gyro-stabilization unit 902-904 may be configured for coupling the interior housing structure 804 with the exterior housing structure 802.

Further, in some embodiments, one or more of the plurality of propulsion units 304-308 may be configured to be detachably attached to the body 302.

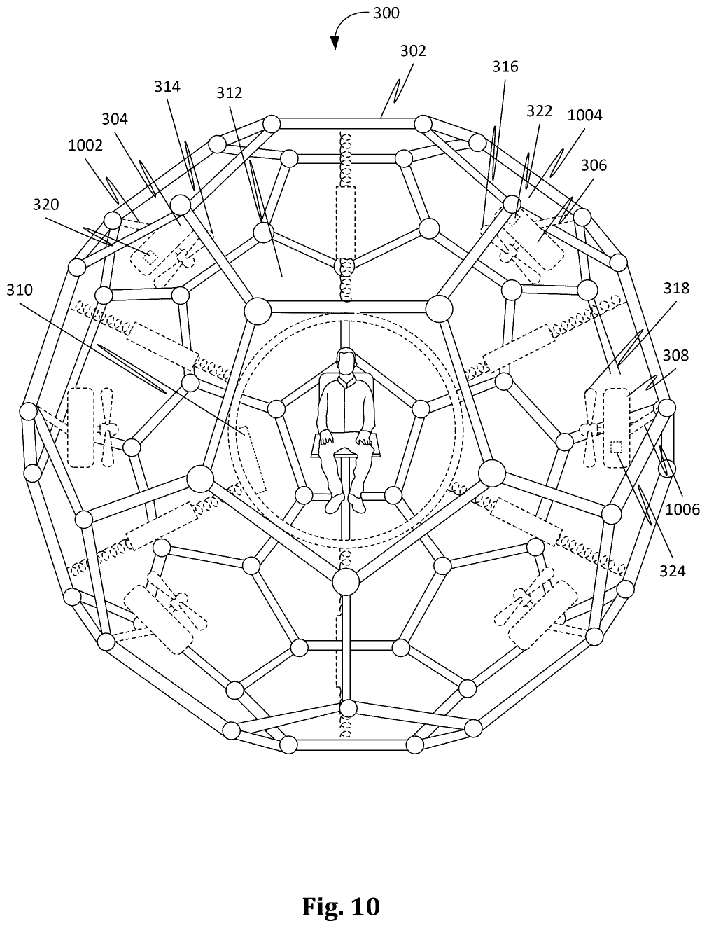

In some embodiments, the transportation system 300 may include at least one gimbal mount 1002-1006, as shown in FIG. 10. The at least one gimbal mount 1002-1006 may include at least one controllable gimbal mount. Further, each of the at least one gimbal mount 1002-1006 may be configured to support one or more of the plurality of propulsion units 304-308. Further, at least a subset of the plurality of propulsion units 304-308 may be mounted using the at least one gimbal mount 1002-1006, the remainder optionally being fixed or mounted otherwise. Further, each of the at least one gimbal mount 1002-1006 may be further configured to permit relative movement of one or more of the plurality of propulsion units 304-308 with respect to the body 302, Further, each of the at least one gimbal mount 1002-1006 may be configured to be either actively controlled via actuators or to passively allow movement. Further, each propulsion unit mounted on a gimbal mount may be configured to adjust its thrust vector based on onboard sensing in the case of a passive gimbal operation. Further, in an embodiment, each of the at least one gimbal mount 1002-1006 may be configured for mounting one or more of the plurality of propulsion units 304-308 in the one or more locations on the body 302. The at least one gimbal mount 1002-1006 may be configured to facilitate movement of one or more of the plurality of propulsion units 304-308 relative to the body 302.

In some embodiments, the at least one gimbal mount 1002-1006 may alternatively be configured as a passive gimbal mount, allowing free relative movement of one or more of the plurality of propulsion units 304-306 without active control inputs. In such cases, directional control of the thrust vector may be achieved by adjusting the propulsion output of one or more of the plurality of propulsion units 304-306 themselves.

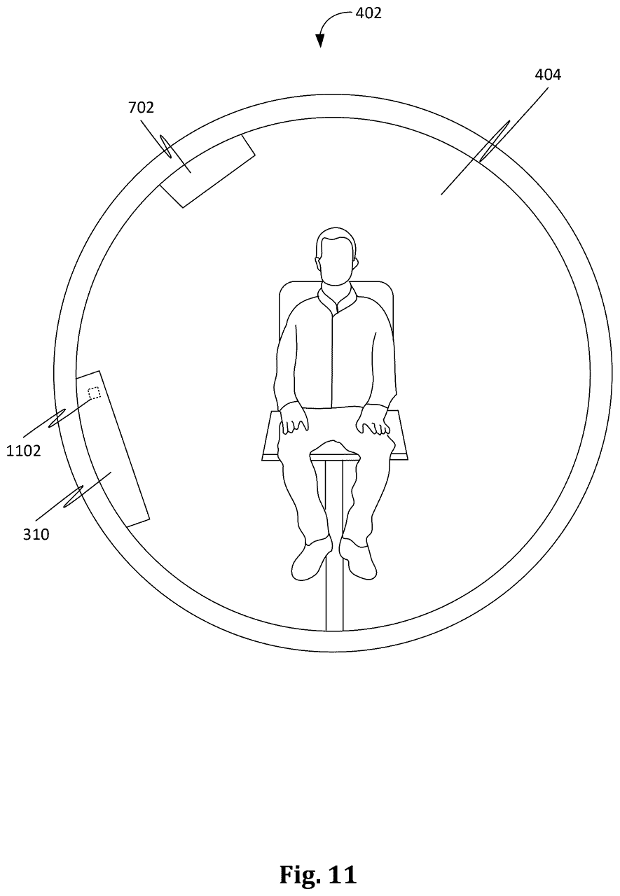

In some embodiments, the transportation system 300 may include an orientation-adjustment unit 1102, as shown in FIG. 11, configured to adjust the orientation of the interior housing structure 804 relative to the exterior housing structure 802 by sending control commands to the gyro-stabilization unit 902-904. The orientation-adjustment unit 1102 may include a controller, processor, processing unit, or computing device configured to implement orientation adjustment functionality.

The orientation-adjustment unit 1102 may be operatively connected to the central flight controller and may access sensor data, the current flight plan, and predicted maneuvers. Based on this information, the orientation-adjustment unit 1102 may dynamically generate and transmit adjustment commands to the gyro-stabilization unit 902-904.

The orientation-adjustment unit 1102 may be designed to maintain the orientation of an operator or occupant inside the one or more housing units 402, or to facilitate adjustments based on an intended maneuver, including maneuvers requiring the one or more housing units 402 to face a direction other than straight ahead. The integration of the orientation-adjustment functionality may enhance user experience and safety by improving comfort and stability during movement.

In some embodiments, the body 302 comprising an aerodynamic profile may be configured to improve the efficiency of at least one movement of the transportation system 300.

In further embodiment, the transportation system 300 may include an aerodynamic-adjustment system. Further, the aerodynamic-adjustment system may be configured to adjust the aerodynamic characteristics of aerodynamic surfaces of the body 302 during the at least one movement, including adjustment of angles of attack and/or modification of aerodynamic profiles. Further, the adjustment may be performed dynamically or based on preprogrammed algorithms according to flight conditions and direction of the transportation system 300. Further, the adjustment may be performed independently of or in coordination with rotation of the body 302. Further, the adjustment facilitates cyclic variation of aerodynamic forces during rotation of the body 302 to enhance flight efficiency in a manner similar to a cyclocopter operation.

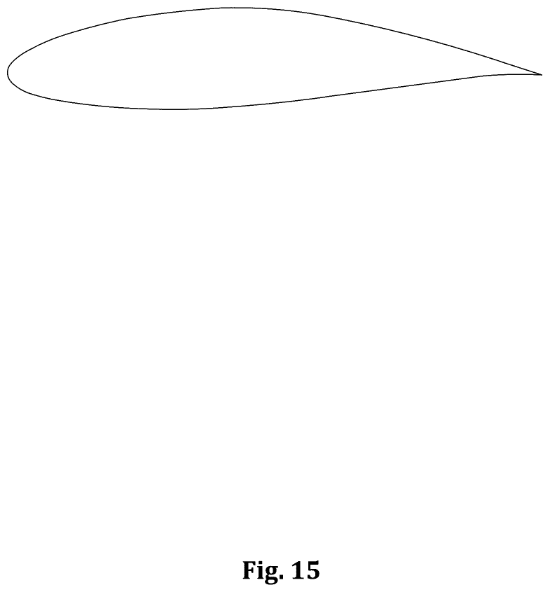

In some embodiments, the adjustment of the orientation of the body 302 may further be based on adjustments of the aerodynamic profile (FIG. 15) of the body 302.

In some embodiments, the producing of the propulsion force produces a movement for the transportation system 300. Further, the movement includes one or more of an aerial movement and a terrestrial movement associated with the transportation system 300. In some embodiments, the terrestrial movement includes a rolling movement corresponding to the movement associated with the transportation facilitated by a rolling motion performed by the body 302.

In some embodiments, at least one of the plurality of propulsion units 304-308 may be configured to autonomously operate with functionality analogous to that of an unmanned aerial vehicle.

In some embodiments, the body 302 may be further configured for provisioning a structural integrity to the transportation system 300.

In some embodiments, the body 302 may be formed as a single piece. Further, the body 302 may be a unitary body, a unibody, etc.

In some embodiments, the body 302 may include an inner layer and an outer layer. Further, the inner layer defines an interior space. Further, the body 302 may be configured for receiving one or more individuals in the interior space through an opening defined by at least one of the inner layer and the outer layer. Further, the body 302 may include a covering layer for openably closing the opening. Further, the outer layer may be spacedly disposed around the inner layer. Further, the body 302 may include a plurality of spacer tethers disposed in a space between the inner layer and the outer layer, and configured for interconnecting the inner layer to the outer layer to maintain a substantially uniform spacing between the inner layer and the outer layer. Further, the space between the inner layer and the outer layer may be pressurized with one or more fluids (air). Further, the body 302 has a substantially spherical shape. Further, the body 302 may be comprised of a material. Further, in an embodiment, the material and the plurality of spacer tethers may be flexible and nonstretchable. Further, the body 302 is rollable on surfaces based on the pressurizing of the space. Further, in an embodiment, the material and the plurality of spacer tethers may be firm and elastically deformable. Further, the body 302 is rollable on the surfaces without the pressurizing of the space. Further, in an embodiment, the body 302 may include a zorb.

FIG. 4 is a front view of the transportation system 300, in accordance with some embodiments.

FIG. 5 is a front view of the transportation system 300, in accordance with some embodiments.

FIG. 6 is a front view of the housing unit 402, in accordance with some embodiments.

FIG. 7 is a front view of the housing unit 402, in accordance with some embodiments.

FIG. 8 is a front view of the housing unit 402, in accordance with some embodiments.

FIG. 9 is a front view of the housing unit 402, in accordance with some embodiments.

FIG. 10 is a front view of the transportation system 300, in accordance with some embodiments.

FIG. 11 is a front view of the housing unit 402, in accordance with some embodiments.

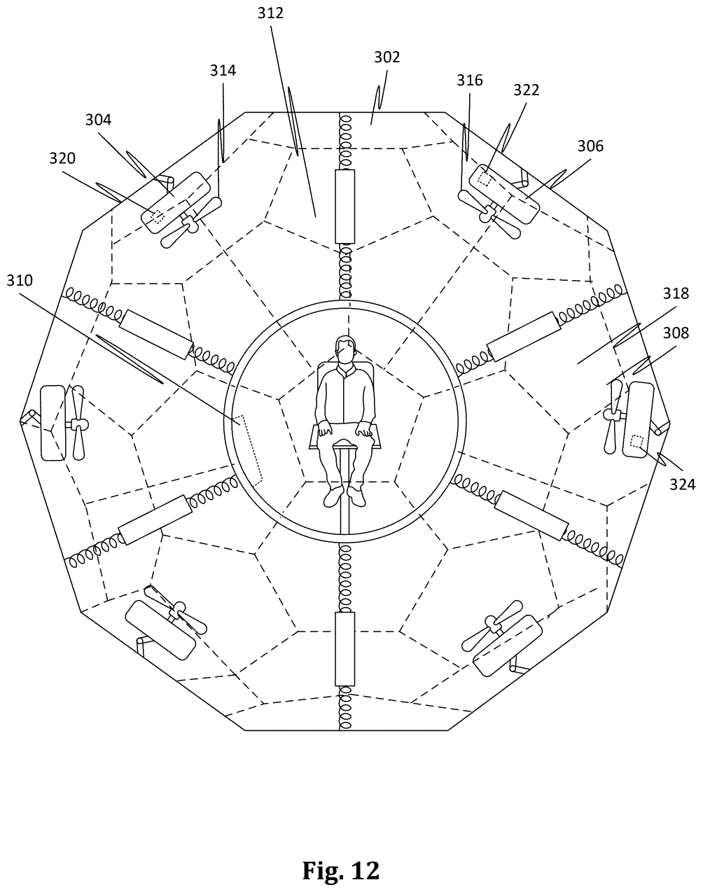

FIG. 12 is a cross sectional view of the transportation system 300, in accordance with some embodiments.

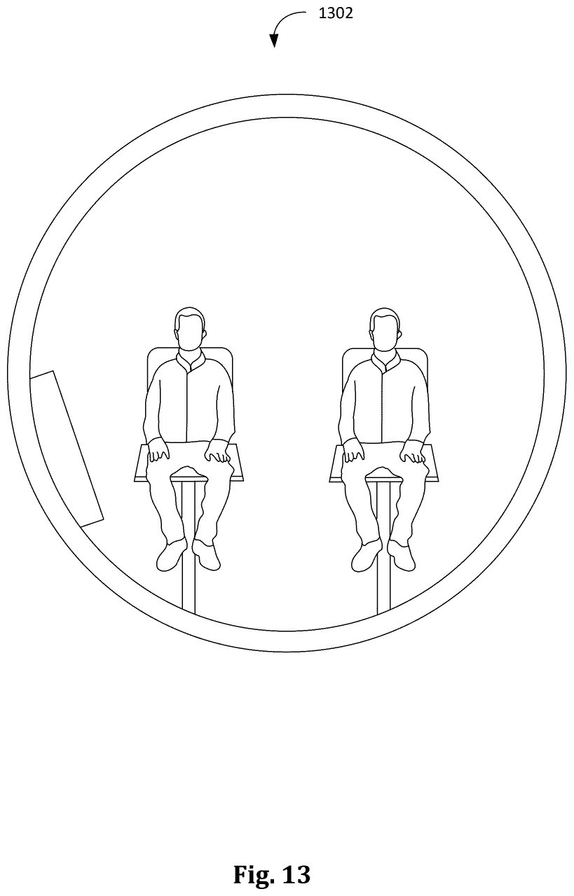

FIG. 13 is a front view of a dual-operator housing unit 1302, in accordance with some embodiments.

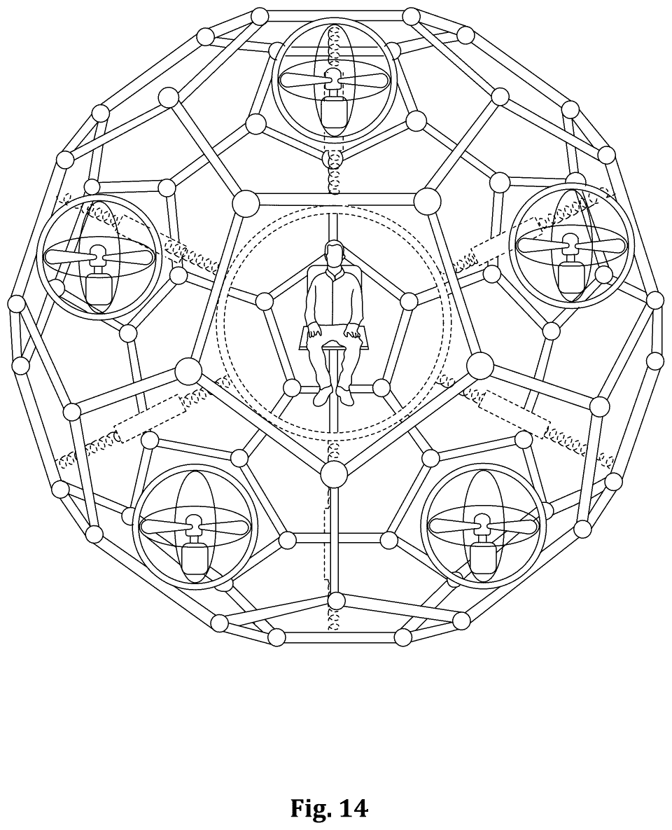

FIG. 14 is a front view of a configuration of circular two-axis gimbal-mounted propulsion units in the transportation system, in accordance with some embodiments.

In this configuration, all propulsion units 304-308 are oriented to direct their thrust vectors substantially toward the ground, either through passive or active circular two-axis gimbal mounts, or through static attachment to the body 302 at a predetermined orientation. This configuration may be designed to maximize the efficiency of vertical takeoff, vertical landing, and altitude maintenance operations.

FIG. 15 is an illustration of an aerodynamic profile associated with a frame of the transportation system, in accordance with some embodiments.

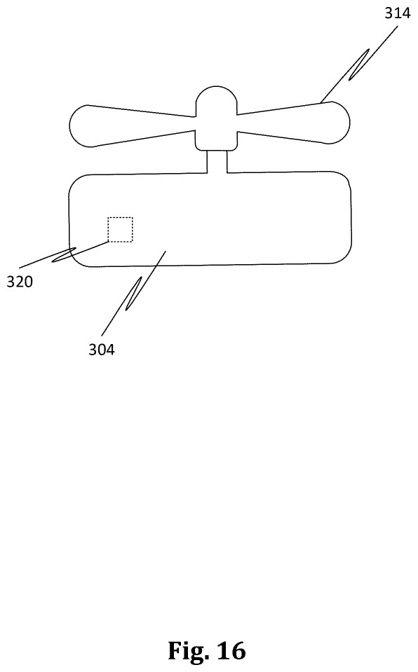

FIG. 16 is an illustration of a propulsion unit of the transportation system, in accordance with some embodiments.

Although the invention has been explained in relation to its preferred embodiment, it is to be understood that many other possible modifications and variations can be made without departing from the spirit and scope of the invention as hereinafter claimed.

What is claimed is:

1. A transportation system comprising:
a body defining an interior space, wherein the body comprises at least one of a polyhedral, a spherical, or other geometric configuration;
a plurality of propulsion units mounted on the body, wherein each of the plurality of propulsion units comprises a thrust-generating mechanism and a power source, wherein the thrust-generating mechanism is disposed within the interior space of the body, on the body, or external to the body, wherein the thrust-generating mechanism is operatively coupled to the power source, wherein the power source is configured to drive the thrust-generating mechanism, wherein the power source is one of: a dedicated source associated with each of the plurality of propulsion units, or a shared source supplying the plurality of propulsion units, wherein the thrust-generating mechanism is configured to produce a propulsion force characterized by at least one of direction and magnitude; and
a control unit operatively coupled to each of the plurality of propulsion units, wherein the control unit is disposed within, disposed on, integrated into, or remote from the body.

2. The transportation system of claim 1, further comprising one or more housing units and/or one or more pilot attachments disposed within the interior space of the body, wherein the one or more pilot attachments is configured to be attached to one or more pilots, wherein each housing unit or each pilot attachment is suspended within the body by at least one connecting element or a suspension mechanism, wherein the at least one connecting element or the suspension mechanism is configured to secure the one or more housing units or the one or more pilot attachments to the body, and further configured to dampen and/or stabilize and/or actively adjust movement of at least one of the one or more housing units or the one or more pilot attachments during operation of the transportation system, wherein each housing unit comprises at least one a seat or a compartment.

3. The transportation system of claim 2, wherein the one or more housing units and/or the one or more pilot attachments is suspended relative to the body by the at least one connecting element or the suspension mechanism, wherein the at least one connecting element or the suspension mechanism is configured to permit and/or actively adjust relative movement and/or dampen and/or stabilize the one or more housing units and/or the one or more pilot attachments relative to the body, wherein the at least one connecting element or the suspension mechanism comprises at least one of an elastically deformable element, a cable, a flexible plate, a spring, a hydraulic, a pneumatic shock absorber, a gyroscopically stabilized arm(s), a magnetic field suspension, an aerodynamic suspension, and a composite structure allowing relative bending between interconnected elements, wherein the at least one connecting element or the suspension mechanism is further configured to absorb impact forces resulting from external collisions or operational movements, wherein the at least one connecting element or the suspension mechanism is implemented using any structure, material, or system capable of allowing relative movement between the one or more housing units and/or the one or more pilot attachments, and the body while dampening and/or stabilizing and/or actively adjusting forces therebetween, including structures and technologies hereafter developed, wherein the at least one connecting element or the suspension mechanism is configured to adjust the position and/or orientation of the one or more housing units and/or the one or more pilot attachments within the body in response to a control input from a pilot or an automated system.

4. The transportation system of claim 1, wherein the body comprises a frame formed by a plurality of interconnected frame members, wherein an arrangement of the plurality of interconnected frame members defines the geometric configuration of the body.

5. The transportation system of claim 1, wherein the plurality of propulsion units are divided into a plurality of propulsion unit groups, wherein the control unit comprises a plurality of flight controller modules, wherein each of the plurality of flight controller modules is exclusively assigned to and configured to independently control a corresponding propulsion unit group, such that failure of one of the plurality of flight controller modules does not impair operation of the other propulsion unit groups, wherein each flight controller module is further configured to communicate with its assigned propulsion unit group via a wired or wireless communication link.

6. The transportation system of claim 1, wherein the control unit further comprises a central flight controller module operatively coupled to the plurality of flight controller modules, wherein the central flight controller module is configured to monitor the operational status of each flight controller module to assume control of a propulsion unit group upon detection of a failure of its assigned flight controller module, wherein the central flight controller module is further configured to dynamically redistribute control among multiple propulsion unit groups to maintain stability of the transportation system following the failure, wherein control signals are distributed from the central flight controller module to the plurality of flight controller modules and further to at least one of the plurality of propulsion units to perform aerial and/or terrestrial movement of the transportation system.

7. The transportation system of claim 1, wherein the control unit is configured to generate control command data for at least one of the plurality of propulsion units, wherein the transportation system is propelled based on the control command data.

8. The transportation system of claim 1, further comprising a communication module configured for receiving user command data from a user device associated with a user, wherein the user command data represents a user command in relation to the producing of the propulsion force, wherein the communication module is communicatively coupled with one or both of at least one of the plurality of propulsion units and the central flight controller module, wherein the producing of the propulsion force characterized by at least one of the direction and the magnitude is further based on the user command data.

9. The transportation system of claim 4, wherein the plurality of interconnected frame members comprises a plurality of tubes and a plurality of connectors, wherein the plurality of tubes are interconnected using the plurality of connectors.

10. The transportation system of claim 2, wherein at least one of the one or more housing units comprises an exterior housing structure and an interior housing structure, wherein the interior housing structure is operatively coupled to the exterior housing structure.

11. The transportation system of claim 10, wherein at least one of the one or more housing units is connected to the body based on a connection between the exterior housing structure and the body using the at least one connecting element or the suspension mechanism.

12. The transportation system of claim 11, further comprising a gyro-stabilization unit operatively coupled between the interior housing structure and the exterior housing structure, wherein the gyro-stabilization unit is configured to stabilize an orientation of the interior housing structure relative to rotation and/or movement of the exterior housing structure.

13. The transportation system of claim 1, further comprising at least one gimbal mount, wherein each of the at least one gimbal mount is configured to support one or more of the plurality of propulsion units, wherein at least a subset of the plurality of propulsion units is mounted using the at least one gimbal mount, the remainder optionally being fixed or mounted otherwise, wherein each of the at least one gimbal mount is further configured to permit relative movement of one or more of the plurality of propulsion units with respect to the body, and is configured to be either actively controlled via actuators or to passively allow movement, wherein each propulsion unit mounted on a gimbal mount is configured to adjust its thrust vector based on onboard sensing in the case of a passive gimbal operation.

14. The transportation system of claim 1, wherein the body comprising an aerodynamic profile is configured to improve the efficiency of at least one movement of the transportation system.

15. The transportation system of claim 14, further comprising an aerodynamic-adjustment system configured to adjust the aerodynamic characteristics of aerodynamic surfaces of the body during the at least one movement, including adjustment of angles of attack and/or modification of aerodynamic profiles, wherein the adjustment is performed dynamically or based on preprogrammed algorithms according to flight conditions and direction of the transportation system, and wherein the adjustment is performed independently of or in coordination with rotation of the body, and wherein the adjustment facilitates cyclic variation of aerodynamic forces during rotation of the body to enhance flight efficiency in a manner similar to a cyclocopter operation.

16. The transportation system of claim 1, wherein the producing of the propulsion force produces a movement for the transportation system, wherein the movement comprises at least one of an aerial movement and a terrestrial movement associated with the transportation system.

17. The transportation system of claim 1, wherein at least one of the plurality of propulsion units is further configured to be detachably attached to the body.

18. The transportation system of claim 17, wherein at least one of the plurality of propulsion units is configured to autonomously operate with functionality analogous to that of an unmanned aerial vehicle.

19. A transportation system comprising:
a body defining an interior space, wherein the body comprises at least one of a polyhedral, a spherical, or other geometric configuration;
a plurality of propulsion units mounted on the body, wherein each of the plurality of propulsion units comprises a thrust-generating mechanism and a power source, wherein the thrust-generating mechanism is operatively coupled to the power source, wherein the power source is configured to drive the thrust-generating mechanism, wherein the power source is one of: a dedicated source associated with each of the plurality of propulsion units, or a shared source supplying the plurality of propulsion units, wherein the thrust-generating mechanism is disposed within the interior space of the body, on the body, or external to the body, wherein the thrust-generating mechanism is configured for generating a propulsion force characterized by at least one of direction and magnitude;
a control unit operatively coupled to each of the plurality of propulsion units, wherein the control unit is disposed within, disposed on, integrated into, or remote from the body; and
one or more housing units and/or one or more pilot attachments disposed within the interior space of the body, wherein the one or more pilot attachments is configured to be attached to one or more pilots, wherein each housing unit or each pilot attachment is suspended within the body by at least one connecting element or a suspension mechanism, wherein the at least one connecting element or the suspension mechanism is configured to secure the one or more housing units or the one or more pilot attachments to the body, and further configured to dampen and/or stabilize and/or actively adjust movement of at least one of the one or more housing units or the one or more pilot attachments during operation of the transportation system, wherein each housing unit comprises at least one a seat or a compartment.

20. A transportation system comprising:
a body defining an interior space, wherein the body comprises at least one of a polyhedral, a spherical, or other geometric configuration;
a plurality of propulsion units mounted on the body, wherein each of the plurality of propulsion units comprises a thrust-generating mechanism and a power source, wherein the thrust-generating mechanism is operatively coupled to the power source, wherein the power source is configured to drive the thrust-generating mechanism, wherein the power source is one of: a dedicated source associated with each of the plurality of propulsion units, or a shared source supplying the plurality of propulsion units, wherein the thrust-generating mechanism is disposed within the interior space of the body, on the body, or external to the body, wherein the thrust-generating mechanism is configured for generating a propulsion force characterized by at least one of direction and magnitude, wherein at least one of the plurality of propulsion units is further configured to be detachably attached to the body, wherein at least one of the plurality of propulsion units is configured to autonomously operate with functionality analogous to that of an unmanned aerial vehicle; and
a control unit operatively coupled with each of the plurality of propulsion units, wherein the control unit is disposed within, disposed on, integrated into, or remote from the body.
